(19) United States
(12) Patent Application Publication
(10) Pub. No.: US 2023/0059392 A1
(43) Pub. Date: Feb. 23, 2023

(54) Lateral Offset Retro Reflector

(71) Applicant: Oren Aharon, Haifa (IL)

(72) Inventor: Oren Aharon, Haifa (IL)

(21) Appl. No.: 17/405,092

(22) Filed: Aug. 18, 2021

(51) Int. Cl. G02B 5/122

(52) U.S. Cl. CPC G02B 5/122

(57) ABSTRACT

To achieve a highly accurate device for back-reflecting a beam with high accuracy over a large lateral offset, an apparatus is disclosed which reflects an incoming beam or image, allowing the reflected beam to be accurately deflected at an angle of 180 degrees over a large offset distance. The reflections inside the device are caused by an accurate 90 degrees reflection on its one end, towards opposite reflecting mirrors which will further bend the beam an additional 90 degrees, creating a total deflection of an incoming beam to be parallel and laterally deflected in respect to the original direction of the incoming beam. The two opposite transmitting and bending surfaces could be based on two mirrors on each end, and preferable at relative angles similar to existing pentaprisms. The said bending mirror surfaces on each end could be coated with anti-reflection coating or with reflection-improving metal coatings.

### BACKGROUND OF THE INVENTION

### I. Field of Invention

The present invention relates to an apparatus for reflecting a light beam to be parallel to the original incoming beam at a predetermined lateral distance dictated by the length of said apparatus.

### 2. DESCRIPTION OF THE RELATED ART

Many optical applications require beam alignment and bore-sighting between several devices which offset in respect to each other, usually called parallax. Seldom, for small parallax, a corner reflector is used to redirect the line of sight from one device to the second one, keeping parallelism between incoming and outcoming lines of sight. A typical corner reflector consists of mutually perpendicular mirrors or flat surfaces to reflect waves parallel to the source but offset. In those cases where the offset between devices is relatively large, this approach is not practical since the corner cube tends to become very large. In prior art devices, a small section of a corner cube is built, having on one side a mirror and perpendicular to this mirror a roof-like mirror element is disposed in such a way that the three mirrors are perpendicular to each other. However, this device is very complicated to make in those instances where high accuracy is required and the beam could be distorted when reflected at the area of the intersection of mirrors in said roof-like element. Scientific and industrial laser applications frequently require inter-alignment between lasers at various wavelengths, sights sensitive to a specific bandwidth wavelength, and even radar performing systems. To overcome these wide requirements, it is preferable to design a mirror-based device with reflectivity over a wide spectral range.

### SUMMARY

The present invention was conceived in order to offer a solution for transferring lines of sights from one optical system to a second optical system which have an offset in between. It is the object of this invention to provide an apparatus that will transfer lines of sight from one device to the other with great accuracy and sufficient performance. Furthermore, this invention could be manufactured as one piece using diamond turning techniques, increasing its applicability and overcoming problems usually related to making such accurate optical devices. Objects and advantages of present invention will be unfolded from the description of broadly described embodiments that follow. To achieve the object in accordance of present invention, the apparatus is used to deflect an incoming beam into its aperture by 180 degrees and offset its exit aperture by an offset according to its mechanical design. The mechanical layout of disclosed art is based on an elongated mechanical basis with built-in four mirrors. Two mirrors are disposed as an input aperture on one end, and at the other end of said elongated mechanical basis—additional two mirrors are used as an exit aperture. The first two mirrors on input aperture will fold an incoming beam by 90 degrees and direct it towards the exit aperture at other end of said mechanical basis to be folded an additional 90 degrees to create a total deflection of 180 degrees. To achieve the objectives in accordance with the present invention, the said first two mirrors at the input aperture should be perpendicular to the mechanical basis and have an angular value between them of 45 degrees. At the other end, a mirror image of the input aperture is created with additional two mirrors with exactly the same specification of 45 degrees in between. Said apparatus is comprised from a set of two mirrors at 45 degrees to each other, mounted on one side of a longitudinal basis, and a second set of two mirrors identical to the first set, mounted on the other side of said longitudinal basis in a mirrored position with respect to said first set. The two said sets of mirrors are preferable machined perpendicularly to said longitudinal basis by diamond turning to achieve highest accuracy and a monolithic structure that being manufactured from a single metal piece is less sensitive to possible deformation due to heat stress. For enhanced reflectivity performance, the mirrors are potentially coated with reflective coating, optimized to best perform at a specific wavelengths' bandwidth.

To summarize, an optical device for deflecting and translating a beam is disclosed, wherein the deflection is 180 degrees and the translation value is dictated by the length of the mechanical system basis. The said deflection is achieved by two perpendicular mirrors to the basis on its one end, and additional two mirrors at its second end. The said two mirrors at input and output end of the mechanical basis have 45 degrees in between, and arranged in such a way that each pair is mirrored to each other. To meet the stringent optical tolerances, this device should be preferable machined using diamond turning technology that can make such a device from a single metal piece. Accordingly, the disclosed art provides an improved and unique beam retro-reflection device, preferable made as one monolithic metal piece.

### BRIEF DESCRIPTION OF THE DRAWINGS

For clarification, the various described embodiments are illustrated below. These figures are not drawn to scale and schematically describe the invention, but do not limit its applications.

FIG. 1 schematically illustrates the prior art.

FIG. 2 illustrates the disclosed art and how the mirrors are disposed in relation to the basis and to each other.

### DETAILED DESCRIPTION OF THE DRAWINGS

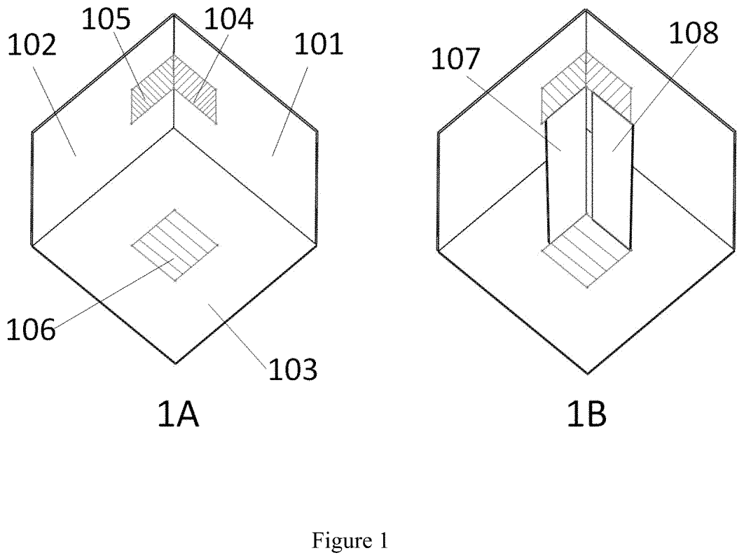

FIG. 1 illustrates prior art technology which relies on a corner cube retro-reflector built out of 3 mirrors mutually perpendicular to each other. This arrangement is well known in optics and will cause an incoming beam to be reflected from each perpendicular mirror and on exit it will be parallel to said incoming beam. For purposes of achieving this effect but with a built-in offset between incoming and outcoming beam, a section of this arrangement is cut out still preserving the mutual perpendicularity of the mirrors. The said 3 mutually perpendicular mirrors are denoted as 101, 102, and 103, and represent a typical corner cube for retro-reflection. In order to achieve offset device, while preserving the retro-reflectivity, a small section from each mirror is selected to build a sectional retro-reflector. The dashed areas denoted as 104, 105 and 106 represent the sectional part of the original corner-cube, by further connecting between the sectional mirrors, a lateral offsetting device with retro-reflection is achieved. FIG. 1B represents such a device wherein the connecting panels are denoted as 107 and 108. This arrangement of prior art is very difficult to build, especially if a monolithic machined device is required. Moreover, the reflected beam performance could be damaged since it has to pass through the roof-like separation created by mirrors 104 and 105. It is the purpose of this invention to provide a solution free of previous art drawbacks.

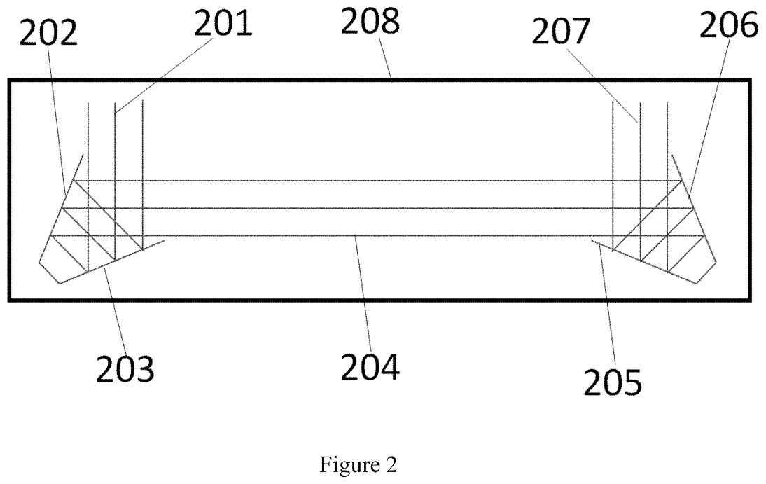

FIG. 2 illustrates a top view of the proposed apparatus, wherein the device includes mirror optics for directing light at a perfect opposite direction of its input direction performing a 180 degrees reflection. The incoming beam 201 is reflected from mirror 203 towards mirror 202, which is at an angle of 45 degrees with said mirror 203. By design, the output direction of the beam is 90 degrees in respect with incoming beam 201. Further, said beam 204 is reflected by mirror 206 towards mirror 205 which reflects said beam in the direction of 207, perpendicular to 204. Again, 206 is deployed to create a perfect 45 degrees angle with mirror 205. Moreover, this arrangement creates an angle of 90 degrees between 203 and 205, completing input to output beam reflection by an angle of 180 degrees. Input direction with different angles will follow the same path and redirected by 180 degrees. That is to say, that regardless of input direction to the device, the back-reflected beam is always exactly 180 degrees. Said mirrors 202, 203, 205, 206 are perpendicularly mounted on a mechanical basis 208. As such, incoming light is always parallel to the outgoing direction to create a perfect back-reflected beam. Having this arrangement will greatly improve the capability of direct machining by using diamond technology. This technology enables to machine the whole device as a single monolithic structure without the need of any screws, bolts or multiple parts. The reflective surfaces will eliminate the needs of correcting optics and special glasses, enabling beam redirection over a wide wavelength spectrum. This also leads to significant reduction of costs and alignment of accurate optical parts, creating a unique solution for back reflection or retroreflection with a built-in offset between the two beams.

1. An apparatus comprising:
a set of two mirrors at 45 degrees to each other, mounted on one side of a longitudinal basis;
a second set of two mirrors identical to the first set, mounted on the other side of said longitudinal basis in a mirrored position with respect to said first set; and
said sets of mirrors are machined perpendicularly to said longitudinal basis.

2. The apparatus of claim 1, where mirrors are coated with reflective coating optimized to better reflect a specific wavelength band.
